(19) United States
(12) Patent Application Publication
(10) Pub. No.: US 2007/0184832 A1
(43) Pub. Date: Aug. 9, 2007

(54) Secure identification of roaming rights prior to authentication/association

(75) Inventors: Stefano Faccin, Fremont, CA (US); Jonathan P. Edney, Cambs (GB)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/651,008

(22) Filed: Jan. 9, 2007

Related U.S. Application Data
(60) Provisional application No. 60/757,484, filed on Jan. 10, 2006.

(51) Int. Cl. H04Q 7/20

(52) U.S. Cl. 455/432.1

(57) ABSTRACT

A mechanism to enable secure identification of roaming rights prior to authentication/association is provided. The mechanism may include using a Roaming ID, and may also include the use of wild cards and group IDs to reduce the length of transmissions. The mechanism may further employ public key infrastructure and puzzles to further enhance security and reduce the risk of denial of service attacks.

### CROSS-REFERENCE TO RELATED APPLICATIONS

The present application is related to and claims the priority of Provisional Patent Application Ser. No. 60/757,484, which is hereby incorporated by reference in its entirety.

### BACKGROUND OF THE INVENTION

1. Field of the Invention

The present invention relates, for example, to a mechanism for IEEE 802.11 to enable secure identification of roaming rights prior to authentication/association.

2. Description of the Related Art

When wireless local area network (WLAN) access points are shared by multiple service providers (e.g. in airport hotspots the airport can own the access point, but service may be provided by other operators such as T-Mobile, Cingular, and the like), the technique called “virtual AP” is used to allow sharing of the access point. From the mobile station point of view it is as if there were several different access points. Multiple service set identifiers (SSIDs) are used by the same access point to support the different service providers

In traditional roaming cases, the mobile station has a roaming client (e.g. T-Mobile connection manager, Boingo connection manager, or the like) that has a roaming directory (which can be implemented as a list of SSIDs for access points to which the station can connect). For a mobile station to select the access point and connect, a valid SSID must be used. That is, the access point must broadcast that SSID and the mobile station must know it. In other words, conventionally the burden of determining whether the mobile station can access or not a given access point based on roaming agreement is left completely to the mobile station, and is traditionally solved by downloading to the mobile station a long list of SSIDs.

With conventional virtual AP solutions, the access point cannot simultaneously broadcast all the SSIDs supported. Therefore, if the mobile station does not detect a supported SSID in the beacons, the mobile station must perform active scanning. That is, the mobile station must send a Probe Request to the access point providing a given SSID. If the access point supports it, it will return a positive answer. When roaming, the list of the mobile station preferred SSIDs can be rather long, which can result in extensive signaling to obtain a valid SSID. For example, the mobile station may have 200 SSIDs, not an unusual number, and only the 189th may be supported; thus, the mobile station may have to perform 189 queries. Previously, it was required that the mobile station perform queries based on known supported SSIDs.

The conventional art thus fails to provide a mechanism for IEEE 802.11 mobility and roaming. Thus, there is the need to allow a mobile station to discover whether it has roaming in a certain access point without the need for the mobile station to try to authenticate/associate and without requiring continuous probing for different SSIDs.

### SUMMARY OF THE INVENTION

The present invention provides, for example, a mobile station including a transmission portion configured to transmit a roaming ID to an access point and a reception portion configured to receive a list of service set identifiers (SSIDs) from the access point.

The present invention also provides, for example, a mobile station including transmitting means for transmitting a roaming ID to an access point and receiving means for receiving a list of service set identifiers (SSIDs) from the access point.

The present invention further provides, for example, a method for obtaining a list of service set identifiers (SSIDs). The method includes transmitting a roaming ID to an access point and receiving a list of SSIDs from the access point.

The present invention additionally provides, for example, an access point including a reception portion configured to receive a roaming ID from a mobile station, a processor portion configured to determine a list of service set identifiers (SSIDs) corresponding to the roaming ID, and transmission portion configured conditionally to transmit the list of SSIDs to the mobile station.

The present invention also provides, for example, an access point including receiving means for receiving a roaming ID from a mobile station, determining means for determining a list of service set identifiers (SSIDs) corresponding to the roaming ID, and transmitting means for conditionally transmitting the list of SSIDs to the mobile station.

The present invention further provides, for example, a method for providing a list of service set identifiers (SSIDs). The method includes receiving a roaming ID from a mobile station, determining a list of SSIDs corresponding to the roaming ID, and conditionally transmitting the list of SSIDs to the mobile station.

### BRIEF DESCRIPTION OF THE DRAWINGS

In the following, the present invention will be described in greater detail based on preferred embodiments with reference to the accompanying drawings in which:

FIG. 1 illustrates a simple embodiment in which an access point is equipped with or is able to obtain a list of valid roaming IDs.

FIG. 2 illustrates a signal flow between a mobile station and an access point in an embodiment of the present invention.

FIG. 3 illustrates a signal flow between a mobile station and an access point in another embodiment of the present invention.

FIG. 4 illustrates a signal flow amongst a mobile station, a visited service provider, and a visited service provider access point in a further embodiment of the present invention.

FIG. 5 illustrates a partial signal flow between a mobile station and a visited service provider access point as a modified flow based on FIG. 4.

FIG. 6 illustrates an embodiment of the present invention including a station and an access point.

### DESCRIPTION OF THE PREFERRED EMBODIMENTS

Certain embodiments of the present invention provide a mechanism to enable a WLAN station (which may also be referred to as a mobile station) to query an access point (AP) to verify whether a roaming agreement is in place between the mobile station service provider and the provider owning the access point. The mobile station may send a Probe Request to the access point providing a Roaming Identifier (Roaming ID) assigned by the mobile station service provider (SP). The access point may use the Roaming ID to verify whether roaming is supported for this mobile station. If roaming is enabled, the access point may reply with a probe response providing the mobile station with the list of SSIDs to be used to connect to the network.

Alternatively, the mobile station may send a Probe Request to the access point providing a string (for example, “3gpp”) to be used as a wild card in probing for supported SSIDs. The access point uses the string to verify whether any SSID matching the string are supported. If roaming is enabled, the access point replies with a probe Response providing the mobile station with the list of SSIDs to be used to connect to the network.

Certain embodiments of the present invention may advantageously move the burden of determining if there is a roaming agreement from the mobile station to the network. Certain embodiments of the present invention may also advantageously not require complex clients in mobile station to manage roaming lists. Additionally, certain embodiments of the present invention may advantageously enable the access point to assert an identity (or several), because the access point may be required to provide a list.

Certain embodiments of the present invention may require definition of a new field in Probe Request message, or definition of a new management/action frame. Additionally, as with all unauthenticated signaling, security of the reply may be able to be guaranteed only through signatures.

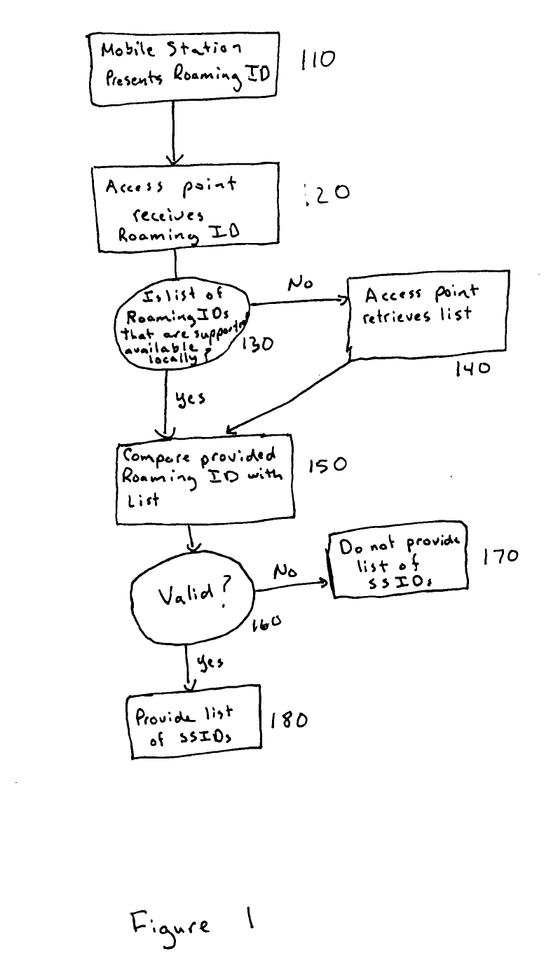

As illustrated in FIG. 1, the mobile station may present 110 a roaming ID. The access point may then receive 120 the roaming ID. The access point may then determine 130 whether a list of roaming IDs that are supported is available locally. If the list is not available locally, the access point may retrieve 140 the list of Roaming IDs from elsewhere. Once the access point has an available list, the roaming ID provided by the mobile station can be compared 150 with the list. The access point may then determine 160 whether the roaming ID is valid. If the roaming ID is not valid, the access point may not provide 170 a list of service set identifiers (SSIDs) to the mobile station. Otherwise, if the roaming ID is valid, the access point may provide 180 a list of SSIDs to the mobile node.

The Roaming ID can be in the form of a network access identifier (NAI) or any other format. In a simple embodiment, illustrated in FIG. 1, the access point can be pre-configured with a list of Roaming IDs supported. Alternatively, the access point may retrieve the information using a protocol (e.g. control and provisioning of wireless access points (CAPWAP)). The access point can compare the provided Roaming ID with the list and determine whether or not to provide a list of SSIDs to the mobile station.

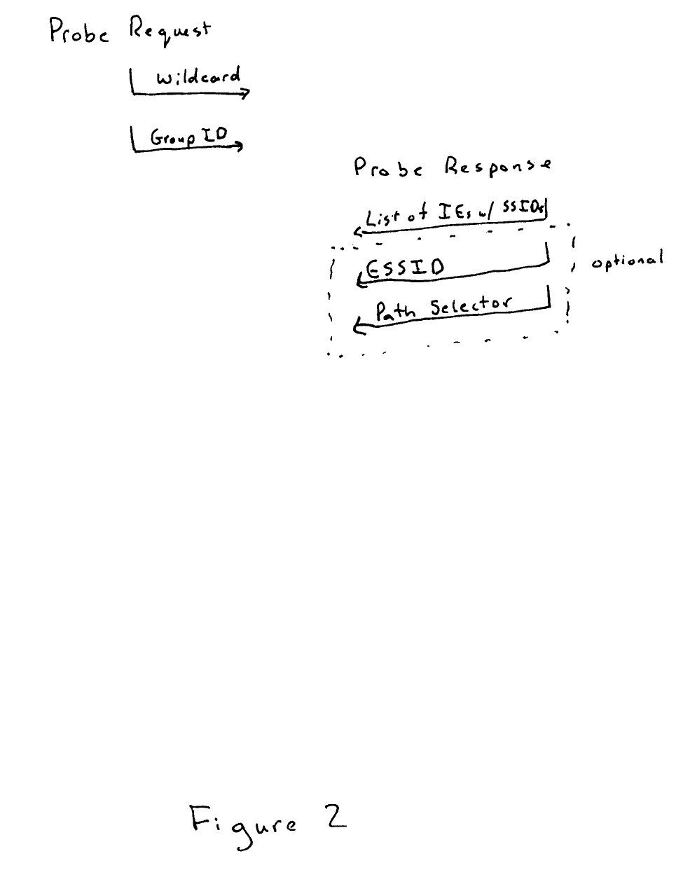

In one embodiment, illustrated in FIG. 2, the Probe Request may be extended to include a wildcard such as “*3G*” or a group identifier. The group identifier could reference a predefined set of SSIDs such as SSID1, SSID2, . . . SSIDn.

The Probe Response is extended with a list of information elements (IEs) containing SSIDs to be used by the mobile station for access while roaming with the RoamingID. If extended service set identifier (ESSID) and Path Selector are adopted, then the ESSID and Path Selector values should also be returned.

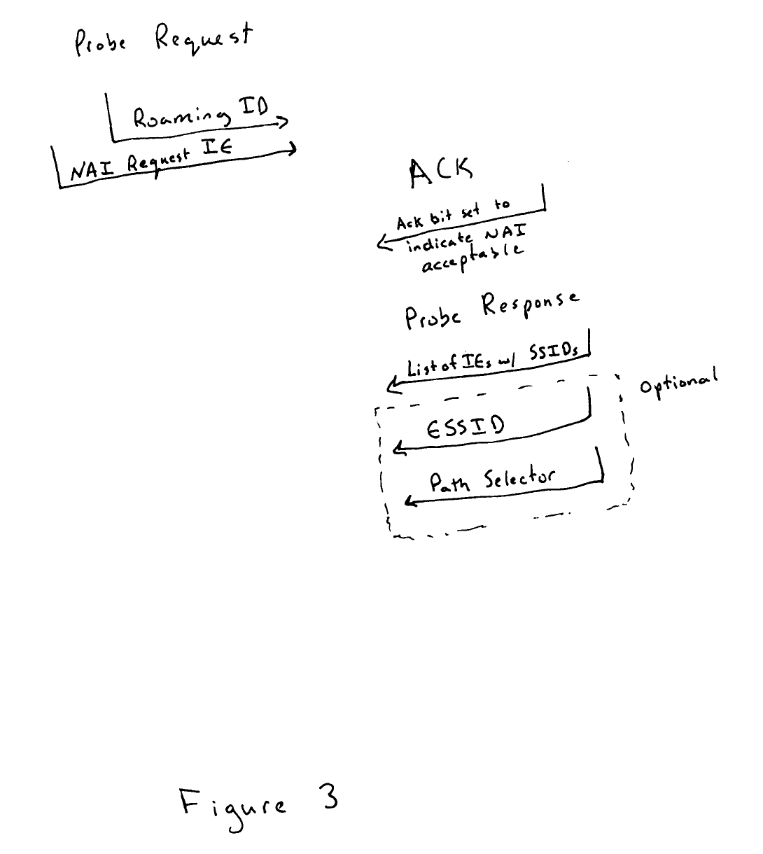

In another embodiment, illustrated in FIG. 3, the Probe Request is extended with the Roaming ID provided in a NAI Request Information Element. If username privacy is required, then the anonymous “@realm” form of NAI may be used. The Ack bit may be set in the Flags octet by the access point to indicate whether the NAI is acceptable or not.

As in the previous embodiment, the Probe Response can be extended with a list of lEs containing SSIDs to be used by the mobile station for access while roaming with the RoamingID. If ESSID and Path Selector are adopted, then also the ESSID and Path Selector values can be returned.

There may be certain security considerations. For example, discovery of a roaming agreement takes place before the mobile station associates and authenticates. Therefore, the mobile station cannot verify the validity of the reply from the access point, as is the case conventionally with all 802.11 management/action frames exchanged before the mobile station associates and authenticates. A rogue access point could thus send a false reply luring the mobile station to try to connect to the rogue access point, or to carry out a denial of service (DoS) attack. However, such a DoS attack is not worse than the DoS attacks that are conventionally possible with Probe Response messages generated by rogue access points, therefore certain embodiments of the present invention do not introduce new security risks.

However, if one wanted to optionally improve on the current security level, to avoid such issues one enhancement of the invention would be to allow the access point to return the information to the mobile station signed in such a way that the mobile station can verify its validity. To achieve this, the mobile station can be configured by the mobile station service provider (SP) with a set of public/private keys needed to verify the signature by the VSP (Visited SP).

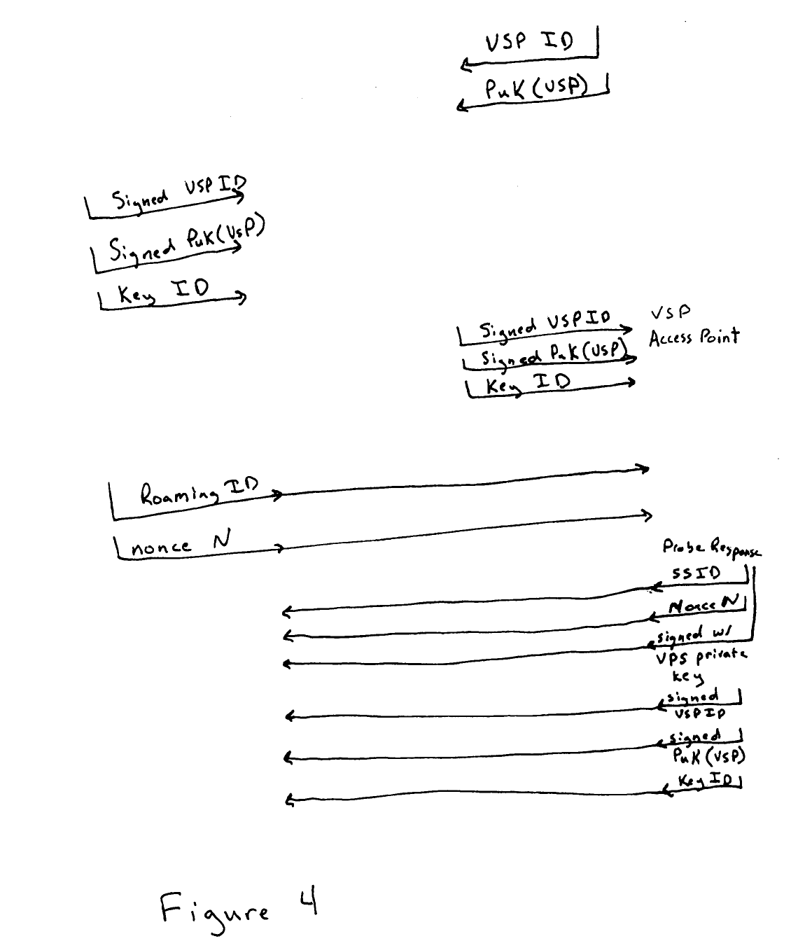

As illustrated in FIG. 4, a roaming partner Visited SP (VSP) sends its identity VSP ID and public key PuK(VSP) to the mobile station SP when the roaming agreement is established and as an off-line operation, and the mobile station SP returns a signed copy of PuK(VSP) and VSP ID, together with a Key ID that denotes which private key has been used by the mobile station SP (in case the mobile station and the mobile station SP share multiple pairs of public/private keys).

The signed copy of PuK(VSP) and VSP ID, together with the Key ID, is distributed by VSP to its access points.

When the mobile station queries the access point with its Roaming ID and providing a nonce N, and the access point determines that the Roaming ID is valid for roaming to that access point, the access point replies with a Probe Response message providing the SSID to be used by the mobile station (together with additional optional information) and the nonce N, both signed together using the private key of the VPS, and provides the signed copy of PuK(VSP) and VSP ID together with the Key ID

Upon receiving such information, the mobile station first verifies the validity of the VSP public key by verifying the signed copy of PuK(VSP) and VSP ID based on the public key of the mobile station SP corresponding to the Key ID.

The mobile station then proceeds to verify the signature of the VSP based on PuK(VSP), and determines the validity of the reply by obtaining the same nonce N it initially sent. The mobile station then associates to the access point using the provided SSID.

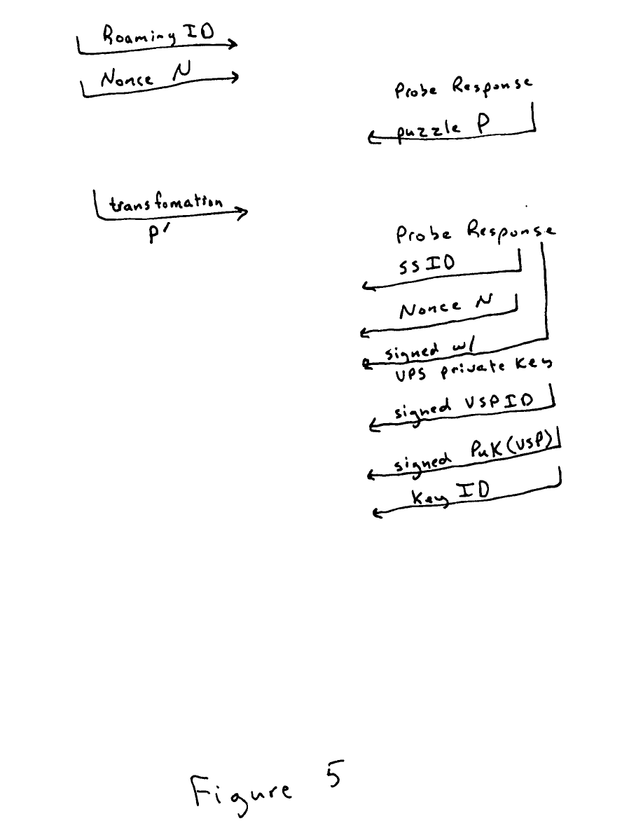

It could be argued that this solution could permit more DoS attacks to the access point, since a rogue mobile station can spoof MAC addresses and send many requests to the access point using valid Roaming ID. This could cause the access point to compute several signatures, thus impacting the access point. To solve this, puzzles can be used. A puzzle is a mathematical value that the receiver needs to transform according to predefined rules and that takes some computation to transform. The sender of the puzzle can have pre-computed the transformation offline. Only a legitimate receiver will spend the time performing such computation, whereas a rogue node would not do that. Puzzles are not waterproof solutions, but serve to limit the number of attacks. With the use of puzzles, the solution works as follows, and is partially illustrated in FIG. 5.

The mobile station is configured by the mobile station SP with a set of public/private keys needed to verify the signature by the VSP. A roaming partner VSP sends its identity VSP ID and public key PuK(VSP) to the mobile station SP when the roaming agreement is established and as an off-line operation, and the mobile station SP returns a signed copy of PuK(VSP) and VSP ID, together with a Key ID that denotes which private key has been used by the mobile station SP. The signed copy of PuK(VSP) and VSP ID, together with the Key ID, is distributed by VSP to its access points.

When the mobile station queries the access point with its Roaming ID and providing a nonce N, and the access point determines that the Roaming ID is valid for roaming to that access point, the access point replies with a Probe Response message providing a puzzle P. Upon receiving the puzzle, the mobile station performs the predefined transformation obtaining P′, and returns it in a new query to the access point. After verifying the validity of P′, and only after doing so, the access point generates a Probe Response message providing the SSID to be used by the mobile station (together with additional optional information) and the nonce N, both signed together using the private key of the VPS, and provides the signed copy of PuK(VSP) and VSP ID together with the Key ID.

Upon receiving the probe response, the mobile station first verifies the validity of the VSP public key by verifying the signed copy of PuK(VSP) and VSP ID based on the public key of the mobile station SP corresponding to the Key ID. The mobile station then proceeds to verify the signature of the VSP based on PuK(VSP), and determines the validity of the reply by obtaining the same nonce N it initially sent. The mobile station associates to the access point using the provided SSID.

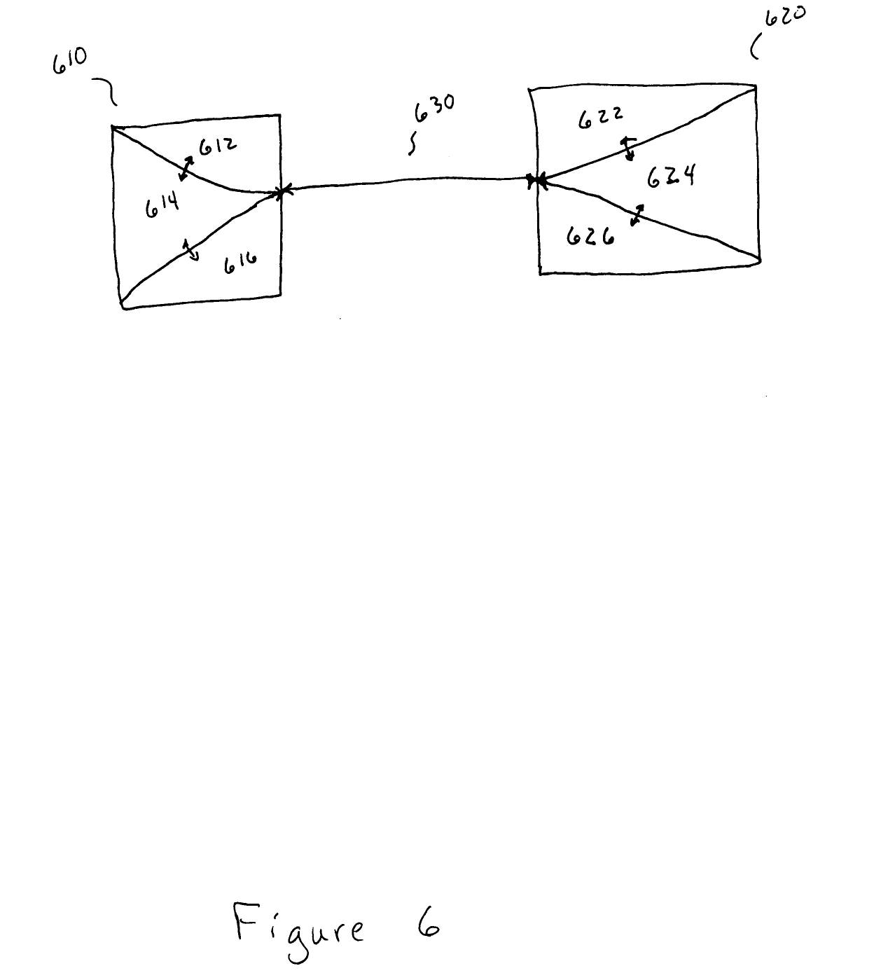

As shown in FIG. 6, a station 610, which may be mobile, may communicate with an access point 620 over a communication medium 630. The communication medium 630 may, for example, be a wireless connection.

The station 610 may include a transmission portion 612, which is able to transmit signals for the station 610 and which is able to communicate with a processor portion 614 of the station 610. The station may also include a reception portion 616, which is able to receive signals for the station 610 and which is able to communicate with a processor portion 614 of the station 610. Although they are illustrated as separate portions, the invention is not limited to embodiments with stations having separate receiving, transmitting, and processing portions.

The access point 620 may similarly include a transmission portion 622, which is able to transmit signals for the access point 620 and which is able to communicate with a processor portion 624 of the access point 620. The access point may also include a reception portion 626, which is able to receive signals for the access point 620 and which is able to communicate with a processor portion 624 of the access point 620. Although they are illustrated as separate portions, the invention is not limited to embodiments with access points having separate receiving, transmitting, and processing portions.

Although embodiments of the present invention are described in terms of a 3GPP WLAN, embodiments of the present invention extend to other contexts and other WLAN environments. Additionally, embodiments of the present invention may not necessarily conform to IEEE 802.11 standards, though some embodiments do so conform.

Furthermore, the mobile station and access point described above may be implemented variously as one of ordinary skill in the art would understand. For example, the above-described transceiver may be implemented as a separate receiver and separate transmitter coupled by a processor. A general purpose computer or a application specific integrated circuit (ASIC) may be used to implement the invention in hardware.

The above description of the invention, therefore, is exemplary and permissive, and should not be understood to limit the invention to the particular described embodiments.

1. A mobile station, comprising:
a transmission portion configured to transmit a roaming ID to an access point; and
a receiving portion configured to receive a list of service set identifiers (SSIDs) from the access point.

2. The mobile station of claim 1, wherein the transmission portion is configured to transmit the roaming ID as a probe request.

3. The mobile station of claim 2, wherein the transmission portion is configured to include, in the probe request, a field that indicates that the mobile station is going to roam using the roaming ID.

4. The mobile station of claim 2, wherein the transmission portion is configured to include, in the probe request, means for verifying whether a roaming agreement is in place between a first provider of services for the mobile station and a second provider of services for the access point.

5. The mobile station of claim 2, wherein the transmission portion is configured to include, in the probe request, a query.

6. The mobile station of claim 5, wherein the transmission portion is configured to include, in the query, a string, a wildcard, or both.

7. The mobile station of claim 1, wherein the transmission portion is configured to transmit, as the roaming ID, a network access identifier (NAI).

8. The mobile station of claim 1, wherein the reception portion is configured to receive the list of SSIDs in a probe response.

9. The mobile station of claim 1, further comprising:
a processor portion configured to select an SSID from the list of SSIDs to engage in roaming using the roaming ID.

10. A mobile station, comprising:
transmitting means for transmitting a roaming ID to an access point; and
receiving means for receiving a list of service set identifiers (SSIDs) from the access point.

11. A method for obtaining a list of service set identifiers (SSIDs), the method comprising:
transmitting a roaming ID to an access point; and
receiving a list of SSIDs from the access point.

12. The method of claim 11, wherein the transmitting comprises transmitting the roaming ID as a probe request.

13. The method of claim 11, wherein the transmitting comprises transmitting a field that indicates that a mobile station is going to roam using the roaming ID.

14. The method of claim 11, further comprising:
verifying whether a roaming agreement is in place between a first provider of services for a mobile station and a second provider of services for the access point.

15. The method of claim 11, wherein the receiving comprises receiving the list of SSIDs in a probe response.

16. The method of claim 11, further comprising:
selecting an SSID from the list of SSIDs to engage in roaming using the roaming ID.

17. An access point, comprising:
a reception portion configured to receive a roaming ID from a mobile station; and
a processor portion configured to determine a list of service set identifiers (SSIDs) corresponding to the roaming ID,
a transmission portion configured conditionally to transmit the list of SSIDs to the mobile station.

18. The access point of claim 17, wherein the reception portion is configured to receive the roaming ID as a probe request.

19. The access point of claim 18, wherein the reception portion is configured to receive, in the probe request, a field that indicates that the mobile station is going to roam using the roaming ID.

20. The access point of claim 18, wherein reception portion is configured to receive means for verifying whether a roaming agreement is in place between a first provider of services for the mobile station and a second provider of services for the access point.

21. The access point of claim 18, wherein the reception portion is configured to receive a query in the probe request.

22. The access point of claim 21, wherein the reception portion is configured to receive as a query, a string, a wildcard, or both.

23. The access point of claim 17, wherein the processor portion is configured to search a master list of SSIDs based on the query and return a corresponding list of SSIDs that correspond to the query.

24. The access point of claim 17, wherein the reception portion is configured to receive, as the roaming ID, a network access identifier (NAI).

25. The access point of claim 17, wherein the transmission portion is configured to transmit the list of SSIDs in a probe response.

26. The access point of claim 17, wherein the processor portion is configured to obtain a list of Roaming IDs when such a list is not available locally.

27. The access point of claim 17, wherein the processor portion is further configured to determine whether a valid roaming agreement is in place between a first provider of services for the mobile station and a second provider of services for the access point.

28. The access point of claim 27, wherein the processor portion is further configured, when the determining indicates that no valid roaming agreement is in place, to decline to provide a list of SSIDs to the mobile station.

29. An access point, comprising:
receiving means for receiving a roaming ID from a mobile station;
determining means for determining a list of service set identifiers (SSIDs) corresponding to the roaming ID; and
transmitting means for conditionally transmitting the list of SSIDs to the mobile station.

30. A method for providing a list of service set identifiers (SSIDs), the method comprising:
receiving a roaming ID from a mobile station;
determining a list of SSIDs corresponding to the roaming ID; and
conditionally transmitting the list of SSIDs to the mobile station.

31. The method of claim 30, wherein the receiving comprises receiving the roaming ID as a probe request.

32. The method of claim 30, wherein the receiving comprises receiving a field that indicates that the mobile station is going to roam using the roaming ID.

33. The method of claim 30, further comprising:
verifying whether a roaming agreement is in place between a first provider of services for the mobile station and a second provider of services for the access point.

34. The method of claim 33, further comprising:
when the verifying results in a negative verification, decline to provide any list of SSIDs to the mobile station.

35. The method of claims 30, further comprising:
search a master list of SSIDs based on a query from the mobile station; and
returning a corresponding list of SSIDs that correspond to the query.

36. The method of claim 30, wherein the transmitting comprises transmitting the list of SSIDs in a probe response.

37. The method of claim 30, further comprising:
obtaining a list of valid Roaming IDs when such a list is not available locally.
